(19) United States
(12) Patent Application Publication
(10) Pub. No.: US 2023/0036719 A1
(43) Pub. Date: Feb. 2, 2023

(54) TELEMATICS UNIT

(71) Applicant: Harman Becker Automotive Systems GmbH, Karlsbad (DE)

(72) Inventor: Dirk Fries, Straubenhardt (DE)

(21) Appl. No.: 17/810,139

(22) Filed: Jun. 30, 2022

(30) Foreign Application Priority Data
Aug. 2, 2021 (DE) 102021119952.2

(51) Int. Cl. H04Q 9/00; H04W 76/10; H04L 67/12; B60R 16/023

(52) U.S. Cl. CPC H04Q 9/00; H04W 76/10; H04L 67/12; B60R 16/023

(57) ABSTRACT

A telematics unit which comprises: a first processor which is designed to establish a connection to the Internet, and a second processor which is designed to enable a wireless communication of the telematics unit with external units, wherein the telematics unit is designed to be arranged in a vehicle, and the first processor and the second processor are arranged in one and the same housing.

### CROSS-REFERENCE TO ALL RELATED APPLICATIONS

The present application claims priority to German Patent Application No. 102021119952.2, entitled “TELEMATICS UNIT,” and filed on Aug. 2, 2021. The entire contents of the above-listed application is hereby incorporated by reference for all purposes.

### BACKGROUND

The present application relates to a telematics unit, in particular to a telematics unit for a vehicle.

Many vehicles today have a telematics unit. In general, an on-board computer which connects the vehicle, for example, to the Internet is referred to here as a telematics unit. The telematics unit usually also collects telemetry data such as, for example, the position or the speed of the vehicle and provides this data to other systems of the vehicle. More and more vehicles additionally also have a so-called Car2X (or V2X “Vehicle-to-everything”) function which allows the vehicle to communicate with other vehicles and with its surroundings.

### OVERVIEW

Proposed is a telematics unit which comprises the following: a first processor which is designed to establish a connection to the Internet and a second processor which is designed to enable wireless communication of the telematics unit with external units, wherein the telematics unit is designed to be arranged in a vehicle, and the first processor and the second processor are arranged in one and the same housing.

Embodiments and variants of the inventive idea are the subject matter of dependent claims.

### BRIEF DESCRIPTION OF THE DRAWINGS

The present application is further explained below in reference to the embodiment examples represented in the figures, wherein identical or similar elements are provided with the same reference numbers.

FIG. 1 schematically shows an exemplary telematics unit using a block diagram.

FIG. 2 schematically shows an additional exemplary telematics unit using a block diagram.

FIG. 3 schematically shows an additional exemplary telematics unit using a block diagram.

### DETAILED DESCRIPTION

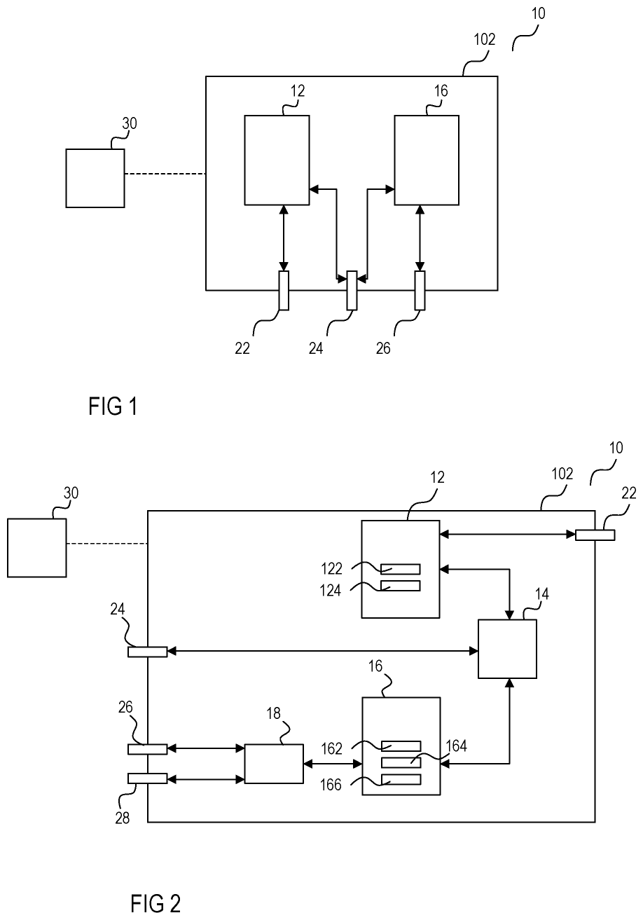

FIG. 1 shows an example of a telematics unit 10. The telematics unit 10 is designed to be arranged in a vehicle and combines the functions of a conventional telematics unit and a Car2X (or V2X “Vehicle-to-everything) unit. The functions of a conventional telematics unit comprise, for example, connecting the telematics unit 10 to the Internet with different Smartphone apps, RFID cards or the like. The telematics unit 10 can, for example, also be designed to generate a vehicle-internal WLAN hotspot. In addition, the telematics unit 10 can optionally be designed to automatically transmit an emergency call in the case of an accident of the vehicle. For this purpose, the telematics unit 10 can collect data of various other control devices of the vehicle and evaluate based on said data whether an accident has occurred. The telematics unit 10 can, for example, also collect telemetry data, such as, for example, the position or the speed of the vehicle and provide this data to other systems of the vehicle. The telematics unit 10 can also collect and evaluate data which it receives, for example, via one or more connected data buses (for example, CAN-bus, LIN-bus, MOST-bus, FlexRay, Ethernet) from other control devices, for many other functions. Thus, for example, the safety of the driver and any passengers can be improved.

A Car2X unit (Car-to-X) is generally designed to communicate with other vehicles and with the surroundings (“X”) of the vehicle in which the Car2X unit is arranged. The communication with other vehicles is here a special case of Car2X also referred to as Car2Car or Vehicle2Vehicle. The “surroundings” (“X”) of a vehicle with which the Car2X unit arranged therein can communicate contains, for example, traffic signals, construction zones, blocking trailers which temporarily block individual lanes of multi-lane roads, or other correspondingly designed road or traffic infrastructure. For example, Car2X makes it possible to control traffic flow, in that a vehicle communicates with a traffic signal toward which it is moving, so that the traffic signal switches prematurely to green and the vehicle can pass the traffic signal without waiting time. Likewise, it is possible, for example, that vehicles are warned in time before mobile roadworks.

The telematics unit 10 according to the example represented in FIG. 1 comprises a first processor 12 which is designed to establish a connection to the Internet and a second processor 16 separate therefrom, which is designed to enable wireless communication of the telematics unit 10 with other external units (for example, in vehicles or traffic infrastructure). The telematics unit 10 is thus designed to provide both conventional telematics functions (by means of the first processor 12) and also Car2X functions (by means of the second processor 16). Since both functions are provided with one and the same unit, this solution can be implemented in a particularly space-saving and cost-effective manner.

The first processor 12 and the second processor 16 are here arranged in the same housing 102. The first processor 12 and the second processor 16 can thus also be supplied with energy by a single power supply 30 (for example, a battery). The power supply 30 can be arranged inside or outside of the housing 102. The telematics unit 10 comprises multiple connection pins 22, 24, 26 which are designed to be connected to external antennas (for example, connection pins 22, 26) or to a data bus (for example, connection pin 24). Thereby, the telematics unit 10 can communicate and exchange data with other control devices of the vehicle in which it is arranged as well as with other vehicles or its surroundings. In principle, the telematics unit 10 can comprise more than the elements and connection pins represented in the figure. However, in the figure, only elements necessary for understanding the present application are represented.

Now, in reference to FIG. 2, an additional example of a telematics unit 10 is described. In this example, the first processor 12 is a communication processor which is designed to process and evaluate data received from other control devices. For this purpose, the first processor 12 can comprise a processing unit 124 designed to process and evaluate data. A processing unit can be, for example, a CPU (central processing unit) or a CPU core or can comprise a CPU or a CPU core. Moreover, the first processor 12 can comprise a baseband processor 122 (modem). Said baseband processor is designed to send data to external units or to receive data from said external units. For this purpose, the telematics unit 10 can comprise an antenna connection 22 which is internally connected to the first processor 12 and is moreover designed to be connected to an external antenna. Thus, the telematics unit 10 can be connected, for example, to the Internet.

The telematics unit 10 can be connected to various other control devices of the vehicle, for example, via a data input/output 24. This data input/output 24 is designed to connect the telematics unit 10 to a data bus and can therefore comprise a data bus interface such as, for example, a CAN interface, a LIN interface, a MOST interface, a FlexRay interface or an Ethernet interface.

Furthermore, in reference to FIG. 2, the telematics unit 10 moreover comprises an input/output unit 14. This input/output unit is connected, on the one hand, to the first processor 12 and, on the other hand, to the data input/output 24. This means that an input/output unit 14 is arranged between the first processor 12 and the data input/output 24. The data input/output unit 14 thus represents an interface between the first processor 12 and the data input/output 24. The input/output unit 14 receives data from the data input/output 24 and provides it to the first processor 12. In the same way, the input/output unit 14 also receives data from the first processor 12 and transfers it to the data input/output 24 in order to provide this data to other applications or control devices in the vehicle.

The second processor 16 is, for example, a Car2X processor. This Car2X processor provides the Car2X functionality to the telematics unit 10. This means that the second processor 16 is designed to enable the communication with other vehicles but also with the surroundings (“X”) of a vehicle (in particular with other telematics units which are arranged in other vehicles or in elements of the traffic infrastructure). For the communication with other vehicles and the surroundings, the second processor 16 can be connected via a high-frequency front end (transmitter/receiver IC, IC=integrated circuit) 18 to at least one antenna connection 26, 28 of the telematics unit 10. Each antenna connection of the at least one antenna connection 26, 28 is designed to be connected to an external antenna. Thereby, the communication with other vehicles and the surroundings is ensured. Via the input/output unit 14, the second processor 16 is also connected to the data input/output 24. The input/output unit 14 thus also represents an interface between the second processor 16 and the data input/output 24. As described above in connection with the first processor 12, the input/output 14 unit receives data from the data input/output 24 and provides it to the second processor 16. In the same way, the input/output unit 14 also receives data from the second processor 16 and transfers it to the data input/output 24 in order to provide said data to other applications or control devices in the vehicle.

The second processor 16 comprises a processing unit 164 which is designed to process and evaluate data. The second processor 16 moreover comprises a baseband processor 162 (modem). Said baseband processor is designed to send data to external units (vehicles, surroundings) or to receive data from said external units. Moreover, the second processor 16 comprises a hardware security module 166 (HSM, Hardware Security Module). The hardware security module 166 is designed to encrypt data to be sent and to decrypt received data. The communication with other vehicles and the surroundings can thus occur encrypted and is consequently secure.

While, in conventional Car2X units arranged in a separate housing separate from the telematics unit, the processor usually comprises an additional media access control (Media Access Control, MAC), this can be omitted in the example represented in FIG. 2. The media access control enables a conventional Car2X unit to communicate with other control devices. This means that the media access control represents an interface between the processor and the data input/output. However, since the telematics unit 10 already comprises an input/output unit 14 which performs precisely this function, the second processor 16 can also use the input/output unit 14 and does not have to provide this function yet again. Thus, the second processor 16 can be implemented smaller and more cost effectively in comparison to the processor of conventional separate Car2X units since it has to provide fewer functions. The different elements of a conventional telematics unit (for example, first processor 12, input/output unit 14) can be kept substantially unchanged in the described combined telematics unit 10 and can also be used by the second processor 16 without substantial changes.

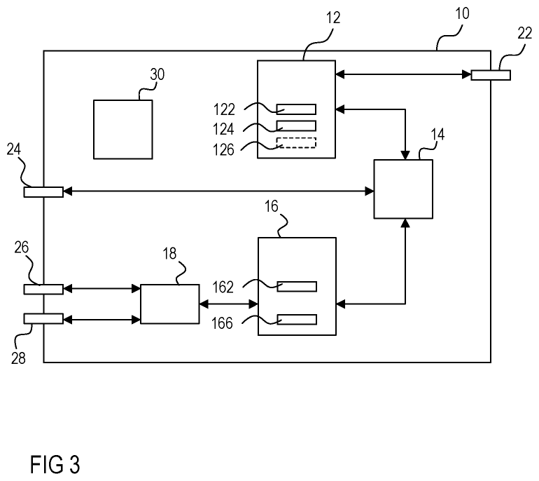

FIG. 3 shows an additional example of a telematics unit 10. The telematics unit 10 represented in FIG. 3 substantially corresponds to the telematics unit 10 of FIG. 2. However, in this additional example, the first processor 12 also performs other additional functions of the integrated Car2X unit. Thus, additional functions of the second processor 16 can be outsourced and said second processor can be implemented even more cost effectively and with fewer functions. In the example in FIG. 3, the second processor 16, for example, does not comprise a processing unit 164. Otherwise, the second processor 16 can substantially correspond to the second processor of FIG. 2. In this example, the first processor 12 can be designed to perform the functions which, in the example of FIG. 2, are performed by the processing unit 164. For example, the first processing unit 124 of the first processor 12 can perform the functions of the processing unit 164 of the second processor 16. If the processing unit 124 of the example of FIG. 2 comprises, for example, resources that are still free, the first processor 12 in the example of FIG. 3 can correspond to the processor of FIG. 2 without changes being necessary.

If the processing unit 124 of the example of FIG. 2 no longer has any free resources, the first processor 12 can comprise an additional processing unit 126 which is designed to perform the functions of the processing unit 164 described in FIG. 2. However, the processing unit 126 is optional and therefore represented with dashed lines in FIG. 3. Since the first processor 12 already comprises a first processing unit 124, providing an additional processing unit 126 usually represents only a slight enlargement which can be implemented more cost effectively in comparison to the arrangement described above in reference to FIG. 2, wherein the second processor 16 comprises this function.

In this example, the Car2X block (second processor 16 and high-frequency front end 18) is thus substantially limited to the communication with external units (other vehicles, traffic infrastructure) and certain security functions (encrypting/decrypting of the transmitted/received data). This solution thus represents a fully integrated solution, wherein the first processor 12 (communication processor) performs a large portion of the tasks of the Car2X unit.

1. A telematics unit which comprises:
a first processor which is designed to establish a connection to the Internet, and
a second processor which is designed to enable a wireless communication of the telematics unit with external units, wherein
the telematics unit is designed to be arranged in a vehicle, and
the first processor and the second processor are arranged in one and the same housing.

2. The telematics unit according to claim 1, wherein
the first processor is a communication processor which is designed to connect the telematics unit moreover with Smartphone applications or RFID cards, to generate a vehicle-internal WLAN hotspot, and/or to collect telemetry data of a vehicle in which the telematics unit is arranged and to provide this data to other control devices of the vehicle, and
the second processor is a Car2X processor which is designed to enable communication of the telematics unit with other telematics units, wherein the other telematics units are arranged in other vehicles or in elements of a traffic infrastructure.

3. The telematics unit according to claim 1, which moreover comprises:
an input/output unit, and
a high-frequency front end, wherein
the second processor is connected via the high-frequency front end to at least one first antenna connection of the telematics unit, and each antenna connection of the at least one antenna connection is designed to be connected to an antenna,
the second processor and the first processor are each connected via the input/output unit to a data input/output, wherein the data input/output is designed to be connected to a wired data network, and
the first processor is connected to a second antenna connection of the telematics unit, and the second antenna connection is designed to be connected to an antenna.

4. The telematics unit according to claim 3, wherein
the second processor comprises a baseband processor which is designed to send data to external units or to receive data from said external units, a processing unit which is designed to process and evaluate data, and a hardware security module which is designed to encrypt data to be sent and to decrypt received data, and
the first processor comprises a baseband processor and a first processing unit.

5. The telematics unit according to claim 3, wherein
the second processor comprises a baseband processor which is designed to send data to external units or to receive data from said external units, and a hardware security module which is designed to encrypt data to be sent and to decrypt received data, and
the first processor comprises a baseband processor and a first processing unit.

6. The telematics unit according to claim 3, wherein
the second processor comprises a baseband processor and a hardware security module, and
the first processor comprises a baseband processor, a first processing unit, and a second processing unit.

7. The telematics unit according to any one of claim 6, wherein the data input/output is designed to connect the telematics unit to a data bus.

8. The telematics unit according to claim 7, wherein the data input/output comprises a CAN interface, a LIN interface, a MOST interface, a FlexRay interface, or an Ethernet interface.

9. The telematics unit according to claim 1, wherein the first processor and the second processor are supplied with energy by one and the same power supply.

10. A telematics unit, comprising:
a first processor configured to establish a connection to the Internet, and
a second processor configured to enable a wireless communication of the telematics unit with external units, wherein
the telematics unit is designed to be arranged in a vehicle, the first processor and the second processor are arranged in one and the same housing, the first processor is a communication processor which is configured to connect the telematics unit moreover with Smartphone applications or RFID cards, to generate a vehicle-internal WLAN hotspot, and to collect telemetry data of a vehicle in which the telematics unit is arranged and to provide this data to other control devices of the vehicle, and the second processor is a Car2X processor which is configured to enable communication of the telematics unit with other telematics units, wherein the other telematics units are arranged in other vehicles or in elements of a traffic infrastructure.

11. The telematics unit according to claim 10, which moreover comprises:
an input/output unit, and
a high-frequency front end, wherein
the second processor is connected via the high-frequency front end to at least one first antenna connection of the telematics unit, and each antenna connection of the at least one antenna connection is designed to be connected to an antenna,
the second processor and the first processor are each connected via the input/output unit to a data input/output, wherein the data input/output is designed to be connected to a wired data network, and
the first processor is connected to a second antenna connection of the telematics unit, and the second antenna connection is designed to be connected to an antenna.

12. The telematics unit according to claim 11, wherein
the second processor comprises a baseband processor which is designed to send data to external units or to receive data from said external units, a processing unit which is designed to process and evaluate data, and a hardware security module which is designed to encrypt data to be sent and to decrypt received data, and
the first processor comprises a baseband processor and a first processing unit.

13. The telematics unit according to claim 11, wherein
the second processor comprises a baseband processor which is designed to send data to external units or to receive data from said external units, and a hardware security module which is designed to encrypt data to be sent and to decrypt received data, and
the first processor comprises a baseband processor and a first processing unit.

14. The telematics unit according to claim 11, wherein
the second processor comprises a baseband processor and a hardware security module, and
the first processor comprises a baseband processor, a first processing unit, and a second processing unit.

15. The telematics unit according to claim 14, wherein the data input/output is designed to connect the telematics unit to a data bus.

16. The telematics unit according to claim 15, wherein the data input/output comprises a CAN interface, a LIN interface, a MOST interface, a FlexRay interface, or an Ethernet interface.

17. The telematics unit according to claim 10, wherein the first processor and the second processor are supplied with energy by one and the same power supply.
